(19) United States
(12) Patent Application Publication
(10) Pub. No.: US 2013/0142206 A1
(43) Pub. Date: Jun. 6, 2013

(54) HIGHER DIMENSIONAL CONSTELLATIONS AND INTERLEAVING FOR 10GBASE-T

(71) Applicant: Broadcom Corporation, Irvine, CA (US)

(72) Inventors: Kishore Kota, Aliso Viejo, CA (US); Ramesh Saripalli, Aliso Viejo, CA (US)

(73) Assignee: BROADCOM CORPORATION, Irvine, CA (US)

(21) Appl. No.: 13/706,584

(22) Filed: Dec. 6, 2012

Related U.S. Application Data
(60) Provisional application No. 61/567,232, filed on Dec. 6, 2011.

(51) Int. Cl. H04L 29/06

(52) U.S. Cl. CPC H04L 69/14
USPC 370/469

(57) ABSTRACT

Systems and methods of processing Ethernet physical layer frames are disclosed. One such system includes processing circuitry operable to map a plurality of bits in an Ethernet media access control (MAC) frame into a plurality of symbols selected from a first multi-dimensional constellation. The first multi-dimensional constellation has a dimension higher than that of a second multi-dimensional constellation defined by IEEE 803.2an. The symbols in the first multi-dimensional constellation have a minimum separation not less than that of the second multi-dimensional constellation. The system also includes second processing circuitry operable to provide noise protection for a plurality of additional bits produced by the mapper as a result of the dimension of the first multi-dimensional constellation being higher than that of the second multi-dimensional constellation.

### CROSS-REFERENCE TO RELATED APPLICATIONS

This application claims the benefit of U.S. Provisional Application No. 61/567,232, entitled “Higher Dimensional Constellations and Interleaving for 10 GBase-T,” filed Dec. 6, 2011, which is incorporated herein in its entirety.

### TECHNICAL FIELD

The present disclosure generally relates to communications systems.

### BACKGROUND

The IEEE 802.3an standard (10 GBASE-T) defines the line code which is used to transmit 10 Gb/s Ethernet over twisted-pair copper cables. One problem encountered in 10 GBASE-T PHYs is an inability to tolerate impulse noise encountered in realistic installations. For instance, it is not uncommon for static discharge events (e.g., from someone opening a door) in a typical datacenter or lab environment to cause bit errors on 10 GBASE-T links (e.g., say on typical UTP cable, such as Cat 6a cables). Such static discharge events may induce impulse noise of sufficient amplitude and duration to overwhelm the channel coding defined in the IEEE 802.3an standard.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram illustrating a transmitter that includes a channel coder utilizing a higher dimension constellation, according to some embodiments disclosed herein.

FIG. 2 is a block diagram illustrating bit order in the transmitter of FIG. 1, according to some embodiments disclosed herein.

FIG. 3 is a block diagram illustrating a bit mapper for a multi-dimension constellation in the transmitter of FIG. 1, according to some embodiments disclosed herein.

FIG. 4 is a block diagram illustrating interleaving in the transmitter of FIG. 1 for an example constellation, according to some embodiments disclosed herein.

FIG. 5 is a block diagram illustrating a system including a physical layer transceiver (PHY) that implements higher dimensional channel coding and/or interleaving, according to some embodiments described herein.

### DETAILED DESCRIPTION

Disclosed herein are various embodiments that provide for systems and methods for higher dimensional constellations and interleaving for 10 GBASE-T. Such systems and methods are referred to herein as multi-constellation systems for brevity. Certain embodiments of multi-constellation systems comprise an interleaving scheme and a scheme to replace the 2D constellation (known as DSQ128) defined by the IEEE 802.3 standard with a 4D constellation, without reducing the minimum distance of the DSQ128 constellation (e.g., with the same minimum distance). Such constellation systems provide the ability to carry 8% additional information. Since the minimum distance of the constellation affects the minimum signal-to-noise ratio (SNR) required to operate at a given bit error rate (BER), this provides a way to transfer more information without significantly affecting the SNR required for operation.

These additional bits can be used in various ways to protect the uncoded bits. For instance, the additional bits can be used to transport either check bits to protect the uncoded bits or implement a retransmission mechanism. The interleaving scheme and the higher-dimensional constellation scheme can be used either independently or together to achieve high degree of impulse/burst noise immunity in a 10 GBASE-T system.

Digressing briefly, it is not uncommon for static discharge events in typical datacenter or lab environment to cause bit errors on 10 GBASE-T links on typical UTP cable (e.g., CAT6a cables). The vulnerability arises from the presence of bits in the line code which are not protected by any channel coding and insufficient interleaving to combat these impulse noise events. That is, the inability of 10 GBASE-T standard line code to tolerate impulse noise events is often a result of uncoded bits (i.e., bits which are transmitted without any channel coding protection) and insufficient interleaving. Channel coding helps the line code achieve immunity to larger noise amplitudes than possible by relying on the minimum distance of the constellation. Interleaving helps to break up the impulse noise (which is concentrated in time) and allow a channel code to correct the bits corrupted by the noise.

Certain embodiments of multi-constellation systems address these and/or other shortcomings of existing systems through advancements in bitmapping/demapping processes and/or improved computations for LLR (log-likelihood ratio) at the input of a standard LDPC (low density parity check) decoder. In some embodiments, the advancements/improvements are performed in a manner that enables the multi-constellation systems to be implemented in a standards-compliant 10 GBASE-T physical layer transceiver (PHY). In one embodiment, the multi-constellation system may operate in one of two selectable modes, such as a 10 GBASE-T compliant mode and a proprietary mode (enabled through modification of an autonegotiation sequence) that utilizes the 4D (or more) constellation and/or interleaving function. For instance, during an autonegotiation process, two devices (or components of those devices) exchange information pertaining to capabilities (e.g., 10BASE, 100Base, etc.). Once the proprietary-equipped device determines based on this exchange that the other device complies with the proprietary mode, the proprietary mode may be switched on. Otherwise, the devices agree to operate in accordance with the standard (non-proprietary, 10 GBASE-T) mode.

One embodiment involves a method operable during transmission in an Ethernet environment. The method includes aggregating a plurality of bits from an Ethernet media access control (MAC) frame into an aggregated block. The method further includes encoding a plurality of bits in the aggregated block by encoding a first portion of the bits in the aggregated block with a first coding scheme and encoding a second portion of the bits with a second encoding scheme, where the first encoding scheme is weaker than the second encoding scheme. The method further includes mapping the channel coded bits into a plurality of symbols selected from a 4D15B multi-dimensional constellation that is partitioned into a plurality of subsets and a plurality of points within each subset. The mapping uses the strongly encoded portion to select one of the subsets and the weakly encoded portion to select one of the points. The symbols in the first multi-dimensional constellation have a minimum distance not less than that of a second multi-dimensional constellation defined by IEEE 803.2an.

Another embodiment involves a device which includes processing circuitry operable to map a plurality of bits in an Ethernet media access control (MAC) frame into a plurality of symbols selected from a first multi-dimensional constellation. The first multi-dimensional constellation has a dimension higher than that of a second multi-dimensional constellation defined by IEEE 803.2an. The symbols in the first multi-dimensional constellation have a minimum separation not less than that of the second multi-dimensional constellation. The device also includes processing circuitry operable to provide noise protection for a plurality of additional bits produced by the mapper as a result of the dimension of the first multi-dimensional constellation being higher than that of the second multi-dimensional constellation.

Another embodiment involves a device which includes processing circuitry operable to map a plurality of bits in an Ethernet media access control (MAC) frame into a plurality of symbols selected from a first multi-dimensional constellation. The first multi-dimensional constellation has a dimension higher than that of a second multi-dimensional constellation defined by IEEE 803.2an. The symbols in the first multi-dimensional constellation have a minimum separation not less than that of the second multi-dimensional constellation. The device also includes processing circuitry operable to provide noise protection for a plurality of additional bits produced by the mapper as a result of the dimension of the first multi-dimensional constellation being higher than that of the second multi-dimensional constellation.

Still another embodiment involves a device that includes channel coding circuitry operable to encode a plurality of bits in an aggregated block formed from an Ethernet media access control (MAC) frame by weakly encoding a first portion of the bits in the aggregated block and strongly encoding a second portion of the bits. The device also includes mapping circuitry operable to map the channel coded bits into a plurality of symbols selected from a first multi-dimensional constellation that is partitioned into a plurality of subsets and a plurality of points within each subset. The mapping circuitry uses the strongly encoded second portion to select one of the subsets and the weakly encoded first portion used to select one of the points.

Yet another embodiment involves a system including circuitry operable to receive interleaved LDPC frames having an interleaving length corresponding to a duration of an impulse noise response. The system also includes circuitry operable to demultiplex symbols of each of the LDPC frames to spread an impulse noise event over plural frames. The system also includes circuitry operable to apply channel coding to the correct corrupted frame responsive to the demultiplexing.

Yet another embodiment involves a system including circuitry operable to transmit interleaved LDPC frames having an interleaving length corresponding to a duration of an impulse noise response. The system further includes circuitry operable to multiplex symbols of each of the LDPC frames to spread an impulse noise event over plural frames. The system further includes circuitry operable to apply channel coding to the correct corrupted frame responsive to the multiplexing.

Having summarized various aspects of the present disclosure, reference will now be made in detail to the description of the disclosure as illustrated in the drawings. While the disclosure will be described in connection with these drawings, there is no intent to limit it to the embodiment or embodiments disclosed herein. On the contrary, the intent is to cover all alternatives, modifications and equivalents included within the spirit and scope of the disclosure as defined by the appended claims.

Before commencing a description of certain embodiments of multi-constellation systems, a brief background of some relevant features of 10 GBASE-T line codes as defined in the 802.3an standard follows. Data and control codes received from the XGMII interface at 10 Gb/s are rate-matched and encoded using a 65B64B code to generate 65-bit blocks. A frame is created from 50 of these 65 bit blocks (i.e., 50*65=3250 bits/frame). A 2D-DSQ128 constellation is used to encode 7 bits into one of 128 points in the constellation. A frame is created from 512 of these 2D-DSQ128 symbols. This means 512*7=3284 bits are used to select the 2D-DSQ128 constellation points transmitted within each frame.

A 12 db set partitioning technique is used to split the 128 points in the 2D-DSQ128 constellation into 16 subsets of 8 points each. The partitioning is done such that the nearest points within each subset have a Euclidean distance of at least 12 db larger than the spacing between the nearest points in the 2D-DSQ128 constellation. The point within each subset is selected using 3 bits and the subset itself is selected using 4 bits. Due to the larger spacing within the subset, the bits used to select these points are not provided any additional protection. As a result, each frame can transport 3*512=1536 uncoded bits/frame. Due to the smaller spacing, the 4*512=2048 bits used to select the subsets are created by appending 325 parity check bits to 1723 information bits. The check bits are created by using a (2048,1723) Low Density Parity Check (LDPC) code defined by the 802.3an standard. Therefore each frame is capable of transporting 1536+1723=3259 bits/frame with only 1723 bits that are protected with a channel code.

The 3250 bits/frame received after encoding the XGMII data and control are appended with 1 undefined auxiliary bit and an 8-bit CRC to form the 3259 bits transported in each frame. These 3259 bits are then encoded into the 512 2D-DSQ128 symbols to form each frame.

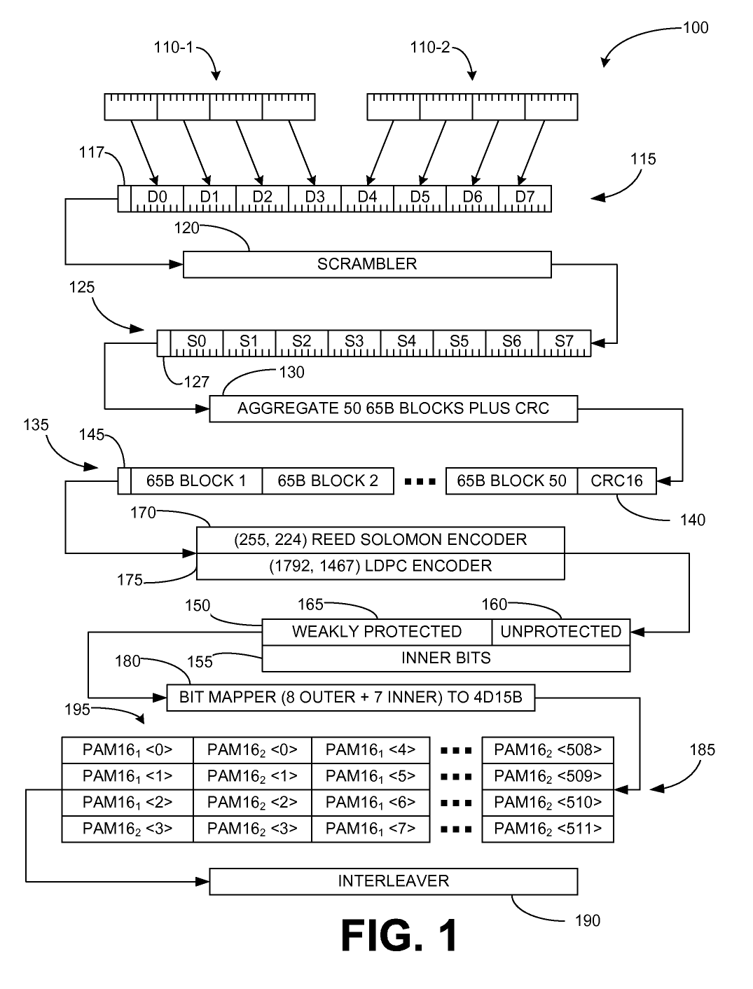

Having summarized some relevant features of the 10 GBASE-T line codes as defined in the 802.3an standard, certain embodiments of multi-constellation systems are disclosed below in the context of sub-features of the system, including 4D constellations for 10 GBASE-T, followed by 4D15B mappers, 4D15B LLR computations, and then interleaving. It should be appreciated by one having ordinary skill in the art that the example process embodiments and/or accompanying logic illustrated in FIGS. 1-5 and described below are merely illustrative of some embodiments, and that other variations with additional logic and/or processes, or in some embodiments with some logic and/or processes omitted, are contemplated to be within the scope of the disclosure.

With regard to 4D constellations for 10 GBASE-T, by switching from a 2D to a 4D (or higher in some embodiments) constellation it is possible to transport more data within each frame while preserving the minimum distance of the points in the 2D constellation. This is done by observing that the standard effectively transports 7 bits/DSQ128 symbol or 3.5 bits/dimension. By restricting each dimension to the same values allowed by the DSQ128 constellation, it is possible to directly construct a 4D constellation which has 215 points with the same minimum distance. This allows mapping 15 bits/4D symbol or 3.75 bits/dimension. One such constellation is described in this disclosure and will be called 4D15B constellation, though it should be appreciated within the context of the present disclosure that other constellations may be used in some embodiments with similar application by embodiments of the multi-constellation system. By constructing the frame using 256 of these 4D15B constellation points, 256 additional bits can be transported per frame. These additional 256 bits/frame can be used in various ways to improve impulse noise immunity.

Turning now to FIG. 1, a transmitter with a channel coder utilizing a higher dimension constellation is now described in further detail. A transmitter 100 receives data and control codes 110-1, 110-2 from an interface such as the 10 Gigabit Media Independent Interface (XGMII) defined by the IEEE. The data rate for the interface may be, for example, 10 GB/s. The data and control codes 110-1, 110-2 are rate-matched and encoded using a 65B64B code. In some embodiments, the transfer from the XGMII interface occurs in groups of two, with a first transfer 110-1 and a second transfer 110-2. The encoding produces a series of 65-bit blocks 115, which may be preceded by a data/control header 117. In the embodiment of FIG. 1, the encoded blocks are scrambled using a scrambler 120, producing a series of scrambled 65-bit blocks 125 preceded by a data/control header 127.

A framer 130 creates a frame 135 from 50 of these 65-bit blocks (i.e., 3250 bits/frame). A 16 bit CRC 140 is appended to the frame 135 to reduce “false packet acceptance” at the MAC. An undefined auxiliary bit 145 may be prepended to the frame 135.

Channel coding is then performed on the frames 135. A 4D15B constellation is used to encode 15 bits into one of 215 points in the constellation. The 4D15B constellation is defined such that spacing between nearest points of this constellation is identical (or nearly identical in some embodiments) to the spacing between nearest points of the 2D-DSQ128 constellation used by the IEEE 802.3an standard. A frame is created from 256 of these 4D15B symbols. This means 256*15=3840 bits are used to select the 4D15B constellation points transmitted within each frame 135. Also, in one embodiment, a 9 db set partitioning technique is used to split the 215 points in the 4D15B constellation into 128 subsets of 256 points each. The partitioning is done such that the nearest points within each subset have a Euclidean distance at least 9 db larger than the spacing between the nearest points in the 4D15B constellation. Partitioning based on other than 9 db may be used in some embodiments.

The point within each subset is selected using 8 bits, hereafter referred as the outer bits 150, and the subset is selected using 7 bits, hereafter referred as the inner bits 160. Due to the larger spacing within the subset, the outer bits 150 require only a weak code (such as a Reed-Solomon code with hard-decision decoding) to protect against impulse noise. The 8*256=2048 outer bits are split into 8 unprotected bits 160 and 2040 weakly protected bits 165 which are formed by appending 248 parity bits to 1792 information bits. In this embodiment, Reed-Solomon encoder 170 generates the parity bits using a (255,224) Reed-Solomon code, though other codes are also possible.

In addition, due to the smaller spacing, the 7*256=1792 inner bits 160 used to select the subsets are created by appending 325 parity check bits to 1467 information bits. The check bits are created by Low Density Parity Check (LDPC) encoder 175, which uses a (1792,1467) LDPC code which is formed by truncating 256 information bits from the (2048,1723) LDPC code defined by the 802.3an standard. As a result the LDPC decoder designed for the IEEE 802.3an standard can be reused with only minor modifications to decode this truncated code.

A bit mapper 180 then maps the outer bits (u7,u6,u5,u4,u3,u2,u1,u0) and inner bits (c6,c5,c4,c3,c2,c1,c0) to a symbol frame 185, where the symbols are taken from a 4D15B constellation using techniques described herein. The symbol frame 185 may also be referred to herein as an LPDC frame 185, since it includes bits protected by the LPDC encoder 175. In the embodiment of FIG. 1, the symbols are provided to an interleaver 190 over a PMA service interface, which is itself divided into four pairs 195.

Hence, as a consequence of the above encoding, each frame is capable of transporting 1467 bits with strong LDPC protection, 1792 bits with a weak RS code and an additional 8 bits unprotected. The 3259 bits/frame payload of the standard IEEE 802.3an can therefore be transported by this new encoding with protection for all the bits of the payload. The 8 additional unprotected bits can be used to replace the 8 bit CRC of the standard with a 16-bit CRC to reduce false packet acceptance at the MAC.

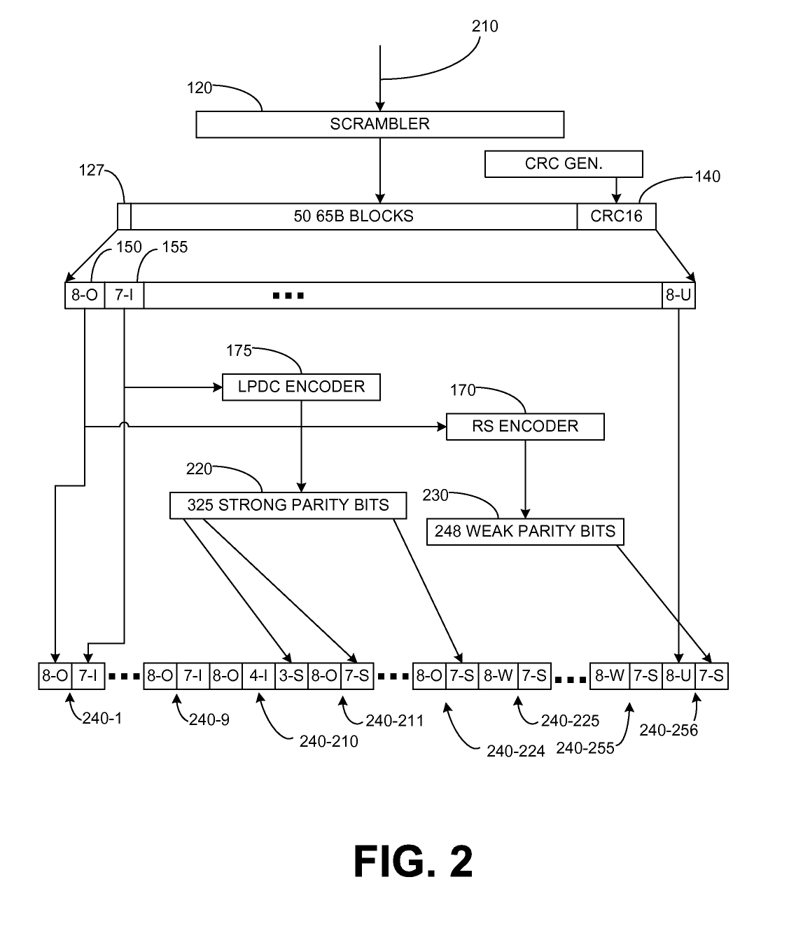

Moving on to FIG. 2, bit ordering in the transmitter of FIG. 1 is now described in further detail. Ethernet data 210 in 65-bit blocks is received at the scrambler 120. The scrambled 65-bit blocks are then aggregated by the framer 130 (FIG. 1) to produce a frame 135, which also includes an auxiliary bit 127 and a 16-bit CRC 140. The 3267 bits in the frame 135 are then processed as shown in FIG. 2. Outer bits 150 are carried into corresponding positions in the final symbols as shown, and are also provided to the Reed Solomon encoder 170. Inner bits 160 are carried into corresponding positions of the final symbols as shown, and are also provided to the LDPC encoder 175. The LDPC encoder 175 produces 325 strong parity bits 220, while the Reed Solomon encoder 170 produces 248 weak parity bits 230. The strong parity bits 220 and the weak parity bits 230 are carried into corresponding positions 240 of the symbols as shown in FIG. 2.

This produces the following symbol arrangement:
symbols 240-1 to 240-209 are formed from 8 outer bits and 7 inner bits;
symbol 240-10 is formed from 8 outer bits, 4 inner bits and 3 of the LDPC check bits;
symbols 240-211 to 240-224 are formed from 8 outer bits and 7 LDPC check bits;
symbols 240-225 to 240-255 are formed from 8 RS check bits and 7 LDPC check bits; and
symbol 240-256 is formed from 8 uncoded bits and 7 LDPC check bits.

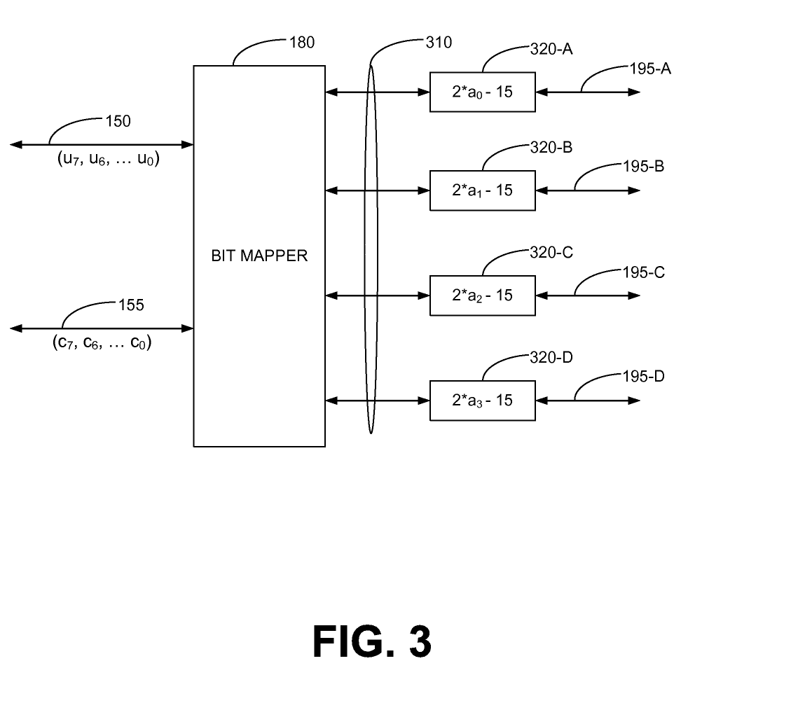

With reference now to FIG. 3, a 4D15B bit mapper for a multi-dimension constellation is now described in further detail. Using 9 db set partitioning (instead of 12 db partitioning which simplifies the equations), one embodiment of a multi-constellation bit mapper 180 maps the outer bits 150 (u₇,u₆,u₅,u₄,u₃,u₂,u₁,u₀) and the inner bits 160 (c₆,c₅,c₄,c₃,c₂,c₁,c₀) to a 4-tuple 310 (a₀,a₁a₂,a₃)

a3=8*u₇+4*u₇̂u₆+2*c₆+c₆̂c₅

a2=8*u5+4*u5̂u4+2*c4+c4̂c3

a1=8*u3+4*u3̂u2+2*c2+c2̂c1

a0=8*u1+4*u1̂u0+2*c0+c6̂c5̂c4̂c3̂c2̂c1

where the symbol “̂” is the XOR operator. Each component of the 4-tuple 310 is then undergoes PAM16 translation by a corresponding translation block 320-A, 320-B, 320-C, 320-D. Each set of translated bits are then transmitted over a pair corresponding pair 195-A, 195-B, 196-C, 195-D of the PMA service interface.

Having described the 4D15B mapper of the multi-constellation system, attention is now directed to an embodiment for performing 4D15B LLR computations. Given the received 4-tuple (x₀,x₁,x₂,x₃) which is the noise corrupted version of the transmitted 4-tuple (a₀,a₁,a₂,a₃), the first step in the LDPC decoder is to calculate the a priori log-likelihood ratios (LLR) for each of bits (c₆,c₅,c₄,c₃,c₂,c₁,c₀).

Step 1: Calculate the 1D LLR for the two lowest significant bits of each symbol:

$$\begin{matrix}{I}_{2 k} = llrb ( {x}_{k} mod 4 ) \\ {I}_{2 k + 1} = llrb ( ( {x}_{k} + 1 ) mod 4 )\end{matrix} \} ∀ k = 0 … 3$$

where the llrb(x) function defined as:

$$llrb ( x ) = \frac{1}{{σ}^{2}} \{ \begin{matrix}x + 0.5 & if 0 \leq x < 0.5 \\ 1.5 - x & if 0.5 \leq x < 2.5 \\ x - 3.5 & if 2.5 \leq x < 4\end{matrix}$$

Step 2: Use the property that the XOR of the LSBs is 0 to compute the LLRs (L₆,L₅,L₄,L₃,L₂,L₁,L₀) for the bits (c₆,c₅,c₄,c₃,c₂,c₁,c₀).

$${L}_{q} = {I}_{q} + {\prod }_{p \neq q} {α}_{p} {min}_{p \neq q} {β}_{p} for q = 0 … 6 \\ where , \\ \begin{matrix}{α}_{p} = sign ( {I}_{p} ) \\ {β}_{p} = abs ( {I}_{p} )\end{matrix} \} ∀ p = 0 … 7$$

A programmable interleaver is now described in more detail. The line code described above provides channel coding for all the bits within a frame. This provides immunity to impulse noise amplitudes which exceed the minimum distance of the constellation. However, the system may utilize additional protection to handle larger duration impulse noise events. The LDPC frame size of the IEEE 802.3an standard is insufficient to handle such noise events encountered in practice.

Since the 4D15B line code described above preserves the LDPC frame size, it may have difficulty with these larger duration noise events. Therefore, in one embodiment, this line code is combined with a programmable interleaver to allow a system-level tradeoff between latency and impulse noise immunity. The interleaving is done after the LDPC frames have been generated as described in the previous section. For example, to provide a 2-frame interleaving, the 256 4D15B symbols of one frame are transmitted interleaved with the 256 4D15B symbols from the next frame.

At the receiver, the interleaved symbols are demultiplexed before decoding. This has the effect of spreading any impulse noise event over multiple frames, which allows the channel coding to correct the corrupted frames. In general, a K-frame interleaver can be defined with K defining the number of frames interleaved, which enables a system-level tradeoff. The de-interleaving process will not be described in detail, as its behavior is complementary to the interleaving process described herein.

Suppose xm[k] is the sequence of transmit symbols on the mth pair at time index k without interleaving. Since 10 GBase-T transmits over 4 pairs, m takes values from {0,1,2,3}. The interleaver output for a depth K is the sequence ym[k] defined as:

$${y}_{m} [ k ] = {x}_{m} [ ( k - ( k \% K ) ⌊ N / K ⌋ K ) + m ⌊ \frac{N}{4} / K ⌋ K ]$$

This interleaver has the effect of splitting the non-interleaver transmit symbols into K streams on each pair and skewing them by └N/K┘K symbols where N=256 is the number of symbols per pair per LDPC frame. In addition, the transmit sequence on the 4 pairs are skewed by an additional quarter frame i.e.

$$⌊ \frac{N}{4} / K ⌋ K$$

symbols. Simulations indicate that K=3 or K=4 provide much improved immunity to burst noises for a latency penalty of approximately 1 μsec.

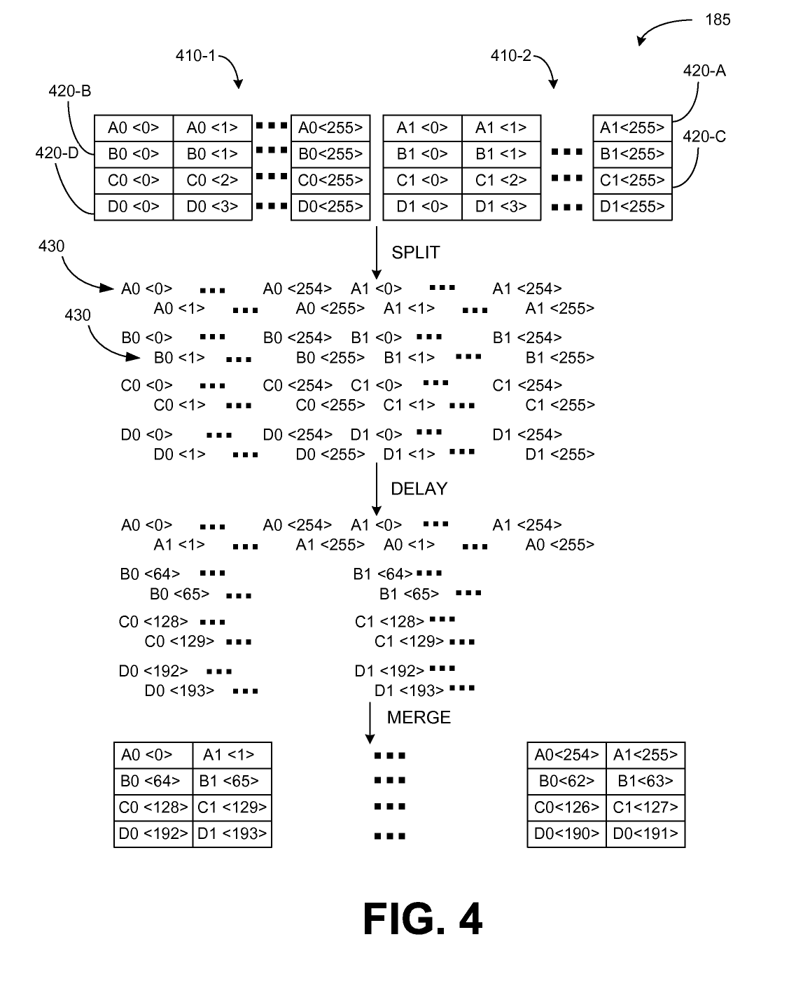

Moving on to FIG. 4, the interleaving process performed by some embodiments of interleaver 190 is described in further detail. The interleaving depth for this example is K=2, but the principles apply to other depths also. A symbol frame 410 includes constellation points associated with strongly coded and weakly coded bits. The symbol frame 410 include four pairs 420A-D, where each pair 420 is associated with a corresponding pair of a PMA service interface. Interleaver 190 splits a first symbol frame 410-1 and a symbol frame 410-2 into K streams 430 on each pair 420. More specifically, symbols from one pair 420 of the first symbol frame 410-1 are alternated among the streams 430, followed by symbols from the second symbol frame 410-2, also alternated among the streams 430. As shown in FIG. 4, the result is even-numbered symbols in the first stream and odd-numbered symbols in the second stream. For example, the output for the first stream of pair 420-A is A0<0>, A0<2> . . . A0<254> then A1<0>, A1<2> . . . A1<254>, while the output for the second stream of pair 420-A is A0<1>, A0<3> . . . A0<255> then A1<1>, A1<3> . . . A1<255>.

The interleaver 190 then introduces a 64 symbol delay between pairs 420. As a result, B0<64> . . . <255> appear before B0<0> . . . <63>, C0<128> . . . <255> appear before C0<0> . . . <127>, and D0<194> . . . <255> appear before D0<0> . . . <193>. Finally, the delayed streams 430 are merged, so that the final order is:

pair 420-A: A0<0> A1<1> . . . A0<254> A1<255>

pair 420-B: B064<0> B1<65> . . .

pair 420-C: C0<128> C1<129> . . .

pair 420-D: D0<192> D1<193> . . .

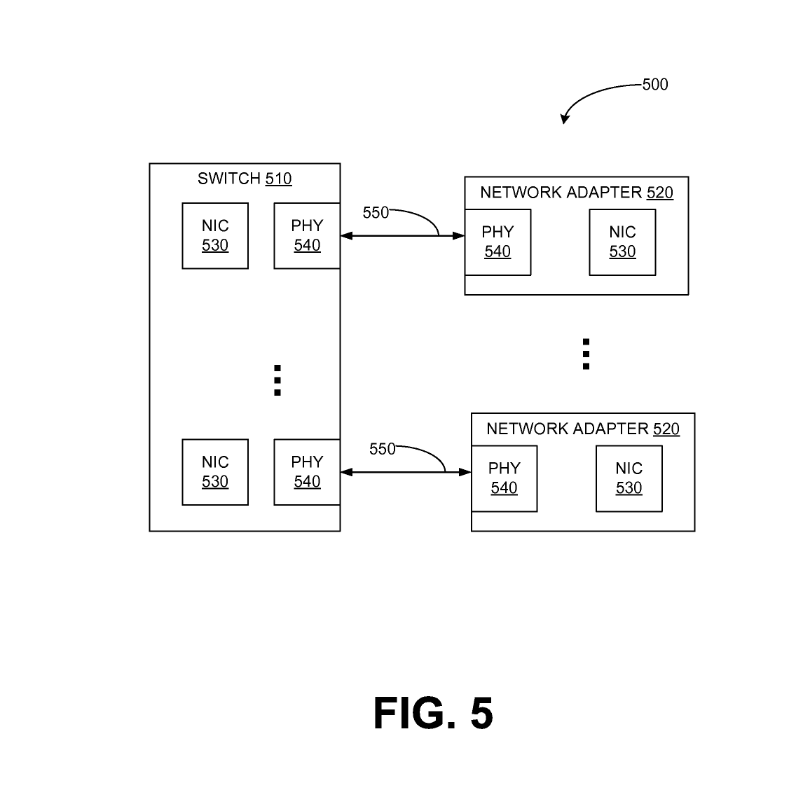

Turning now to FIG. 5, shown is a block diagram of a system that includes a physical layer transceiver (PHY) operable to implement the higher-dimension constellation encoding and/or interleaving techniques described herein. The system 500 includes an Ethernet switch 510 and one or more network adapters 520. The switch 510 includes a network interface controller (NIC) 530 and a PHY 540, as does each network adapter 520. The PHY 540 of each NIC 530 is coupled via a twisted pair link 550 to a corresponding PHY 540 on the switch 510. One or more of PHYs 540 implements the higher-dimension constellation encoding and/or interleaving techniques described herein by including some combination of the framer 130, encoders 170 and 175, bit mapper 180, and interleaver 190 as described with reference to FIG. 1 and FIG. 2. In some embodiments, this logic may be implemented in a Physical Convergence Sublayer (PCS) of the PHY.

One or more benefits may inure to one or more embodiments of the disclosure. For instance, simplicity of this multi-constellation scheme aligns well with a standards compliant 10 GBASE-T transceiver. Adding this mode to an existing transceiver requires relatively minor changes to mapper/demapper and LLR preprocessing for the LDPC decoder. In addition, there is minimal SNR loss compared to standard line code. The 4D constellation has the same minimum distance compared to the standard compliant 2D line code (DSQ128) but transports 8% more bits. The resulting line code reuses the same LDPC decoder as the standard and requires only a different LLR computation block which comprises only a small portion of the entire LDPC decoder block. As another example, spectral compatability with 10 GBASE-T: The transmitted signal is indistinguishable from the standard 10 GBASE-T signal. This means crosstalk from this signal is also indistinguishable from 10 GBASE-T.

Another benefit is that one or more of the multi-constellation systems described herein supports the full 10 GBASE-T data rate. In addition, latency is minimal compared to retransmission schemes which require communication and buffering to implement. To fully combat the impulse noise events an interleaver is to be added. The length of this interleaver is a function of the duration of the impulse noise that needs to be tolerated. In the best case scenario, without an interleaver the latency is identical to a standard 10 GBASE-T receiver. A programmable interleaver can provide a tradeoff between impulse noise immunity and latency. Further, there need be no changes in AFE or DSP requirements compared to standard 10 GBASE-T receivers. Although the elimination of uncoded bits relaxes the stringent bit error requirements on the AFE imposed by the standard 10 GBASE-T line code, this benefit cannot be exploited in a part which also needs to be standard compliant. All the DSP processing (i.e., echo/NEXT/FEXT cancellation and equalization) is identical to a standard 10 GBASE-T receiver.

Certain embodiments of multi-constellation systems as described above and illustrated in FIGS. 1-5 may be implemented in hardware, software, firmware, or a combination thereof. When embodiments of the multi-constellation system are implemented in hardware, the multi-constellation system may be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. In the embodiments where the multi-constellation systems are implemented in software or firmware by instructions executing on a processor, such firmware and/or software is stored in a non-transitory computer readable medium (e.g., memory) and executed by a suitable instruction execution system.

It should be emphasized that the above-described embodiments are merely examples of possible implementations. Many variations and modifications may be made to the above-described embodiments without departing from the principles of the present disclosure. For instance, several solutions to the impulse noise problem comprises the implementation of deeper interleaving and some form of channel coding on all the transported bits. This can be achieved in some variations of the above-described embodiments with a wide variety of line codes (i.e. combination of constellation and channel coding) by trading off cable length for this added ability to tolerate impulse noise. An alternate solution is to use a retransmission mechanism which also requires some way to transport additional information and incurs higher latency. The various schemes can also to varying degrees co-exist within a standards-compliant 10 GBASE-T PHY. All such modifications and variations are intended to be included herein within the scope of this disclosure and protected by the following claims.

At least the following is claimed:

1. A device comprising:
processing circuitry operable to map a plurality of bits in an Ethernet media access control (MAC) frame into a plurality of symbols selected from a first multi-dimensional constellation, the first multi-dimensional constellation having a dimension higher than that of a second multi-dimensional constellation defined by IEEE 803.2an, the symbols in the first multi-dimensional constellation having a minimum separation not less than that of the second multi-dimensional constellation,
wherein the processing circuitry is further operable to provide noise protection for a plurality of additional bits produced by the mapper as a result of the dimension of the first multi-dimensional constellation being higher than that of the second multi-dimensional constellation.

2. The device of claim 1, wherein the processing circuitry is further operable to provide the noise protection by enabling retransmission of at least a portion of the additional bits.

3. The device of claim 1, wherein the processing circuitry is further operable to provide the noise protection by channel coding at least a portion of the additional bits.

4. The device of claim 3, wherein the channel coding comprises Reed-Solomon coding.

5. The device of claim 3, wherein the channel coding comprises LDPC coding.

6. The device of claim 3, wherein a remaining portion of the additional bits are uncoded.

7. The device of claim 1, wherein the symbols in each dimension of the first multi-dimensional constellation are restricted to a plurality of symbols in the second multi-dimensional constellation.

8. The device of claim 1, wherein the second multi-dimensional constellation comprises a DSQ128 constellation.

9. The device of claim 1, wherein the dimension of the first multi-dimensional constellation is 4.

10. A device comprising:
channel coding circuitry operable to encode a plurality of bits in an aggregated block formed from an Ethernet media access control (MAC) frame by weakly encoding a first portion of the bits in the aggregated block and strongly encoding a second portion of the bits; and
mapping circuitry operable to map the channel coded bits into a plurality of symbols selected from a first multi-dimensional constellation that is partitioned into a plurality of subsets and a plurality of points within each subset, the mapping circuitry using the strongly encoded second portion to select one of the subsets and the weakly encoded first portion used to select one of the points.

11. The device of claim 10, wherein the channel coding circuitry further comprises a Reed Solomon encoder operable to weakly encode the first portion of the bits.

12. The device of claim 10, wherein the channel coding circuitry further comprises an LDPC encoder operable to strongly encode the second portion of the bits.

13. The device of claim 10, wherein the channel coding circuitry is further operable to leave a third portion of the bits uncoded.

14. The device of claim 10, wherein the first multi-dimensional constellation has a dimension higher than that of a second multi-dimensional constellation defined by IEEE 803.2an, the symbols in the first multi-dimensional constellation having a minimum distance not less than that of the second multi-dimensional constellation.

15. The device of claim 10, wherein the symbols in each dimension of the first multi-dimensional constellation are restricted to a plurality of symbols in the second multi-dimensional constellation.

16. The device of claim 10, wherein the second multi-dimensional constellation comprises a DSQ128 constellation.

17. The device of claim 10, wherein the dimension of the first multi-dimensional constellation is 4.

18. A system, comprising:
circuitry operable to:
receive interleaved LDPC frames having an interleaving length corresponding to a duration of an impulse noise response;
demultiplex symbols of each of the LDPC frames to spread an impulse noise event over plural frames; and
apply channel coding to the correct corrupted frame responsive to the demultiplexing.

19. The system of claim 18, wherein the LDPC frames are generated in accordance with 10 GBASE-T and a 2D constellation.

20. The system of claim 18, wherein the LDPC frames are generated in accordance with 10 GBASE-T and a multi-dimensional constellation greater than 2D.
